(19) United States
(12) Patent Application Publication
(10) Pub. No.: US 2015/0163654 A1
(43) Pub. Date: Jun. 11, 2015

(54) E911 GEO-LOCATION DETECTION FOR MOBILE DEVICES

(71) Applicant: MediaFriends, Inc., Cambridge, MA (US)

(72) Inventors: Eugene Lee Lew, Olney, MD (US); Vasileios John Gianoukos, Winchester, MA (US)

(21) Appl. No.: 14/564,491

(22) Filed: Dec. 9, 2014

Related U.S. Application Data
(60) Provisional application No. 61/914,107, filed on Dec. 10, 2013.

(51) Int. Cl. H04W 4/22; H04W 4/02

(52) U.S. Cl. CPC H04W 4/22; H04W 4/02

(57) ABSTRACT

A method to provide enhanced 911 services on mobile devices includes determining that a function or application on the mobile device requires a geo-location of the mobile device enabling, determining that a user has blocked the geo-location features of the mobile device or the geo-location features of the device are otherwise disabled, checking a whitelist to determine whether the function/application is allowed to override the user's or device's settings for geo-location purposes and determining that destination of the message is 911. If the conditions for override are met, the method overrides the user preference or device settings and provides the geo-location of the mobile device to the function/application and displays the override condition to the user.

### FIELD OF THE INVENTION

The present invention relates to messaging and communications, and to mobile devices and enhanced 911 emergency services.

### BACKGROUND

People without telephone service sometimes need to use 911 emergency services. These people might have the ability to send text messages. Determining a 911 caller's location is crucial in providing emergency services.

Texting to 911 is different from making a voice call to 911 in the following way: when the caller makes a voice call to 911, the call taker will typically receive the caller's phone number and the caller's approximate location automatically, This is called “Enhanced 911” or “E911.” However, in most cases when the caller texts 911 from a wireless phone or other text, enabled device, the call taker will not receive this automated information. For this reason, if the caller sends a text message Lo 911, it is important to give the 911 call taker an accurate address or location as quickly as possible.

Text-to-911 is the ability to send a text message to reach 911 emergency call takers from a mobile phone or device. In the future, text-to-911 will be widely available in the United States Some of the text-to-911 systems will include the delivery of location information and support for text-to-911 when roaming. Mobile phones and other devices have the capability to determine an approximate location either by using an optional integrated GPS system, by using cell phone tower triangulation techniques or other methods. However often use this location information is blocked by device settings in the mobile phone operating system Or by a user preference to maintain privacy. Therefore in an emergency, this vital information is not available when used to send a text message to 911.

### SUMMARY OF THE INVENTION

Enhanced 911 services is achieved in accordance with embodiments disclosed herein by a system and method which enables the detection of the actual geo physical location of the mobile device including, when necessary, overriding of a user's personal preferences or device settings on the device if the user attempts to perform a function that requires the actual geo-physical location of the device as part of the function in conjunction with emergency services.

Such a system and method solves a problem that has not been solved yet in a manner that is subtle and does not impinge on the privacy or operational preferences of users except for in emergencies or designated matters where it is desirable or necessary to override the users own privacy settings or operational preferences. This selective override enables enhanced 911 (also referred to as SMS911 or enhanced text-to-911 to function.

In one embodiment, a technique to provide enhanced 911 services on mobile devices includes determining that a function/application on the mobile device requires a geo-location of the mobile device enabling, determining that a user has blocked the geo-location features of the mobile device, checking a whitelist to determine whether the function/application is allowed to override the user's preference for geo-location purposes, determining that destination of the message is 911, overriding the user preference and providing the geo-location of the mobile device to the function/application and displaying the override condition to the user. In another embodiment, the technique includes checking a whitelist to determine whether the function/application is allowed to override the device's settings for geo-location purposes and overriding the device's settings and providing the geo-location of the mobile device to the function/application.

These techniques facilitate including geo-location information in a SMS911 text message in an emergency even if a user has configured user preferences or device settings to prohibit access to geo-location information for privacy or other concerns. In another embodiment, the override condition is displayed to the user. In another embodiment, a failed attempt to override blocked access to geo-location data is displayed to the user.

The techniques disclosed herein are not limited to E911 applications and can also be used for other applications which require geo-location information but might be typically blocked by the user. The these applications the user might give explicit permission for a given application to override a blocked condition or the user might rely on the whitelist mechanism to determine what application have access to the geo-location information.

Other embodiments of the invention that are disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor and a display, programs the processor to perform the operations disclosed herein. Such arrangements are typically provided as software, code and/or other data (e.g., data structures) arranged or encoded on a computer readable medium such as an optical medium (e.g., CD-ROM), hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein. Other configurations include web applications, browsers, IP applications and data enabled device applications as will be explained in more detail.

It is understood that the features of the social messaging hub can be embodied strictly as a software program, as software and hardware, or as hardware alone such as within a single processor or multiple processors, or within an operating system or within a software application.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention. These and other features of the invention will be understood from the description and claims herein, taken together with the drawings of illustrative embodiments, wherein:

FIG. 1 is a schematic illustration of a mobile device placing an SMS911 call including geo location information in accordance with one example embodiment disclosed herein;

FIG. 2 is schematic diagram of the components of the mobile device of FIG. 1; and

FIG. 3 is a flow chart of processing steps performed for placing an SMS911 call including geo location information from the mobile device of FIG. 2.

### DETAILED DESCRIPTION

In general smart mobile devices and corresponding operating systems and applications cannot override a user's preference settings. To enable an override in certain emergency situations would require the user to make changes in preference setting before, for example, texting a message to a 911 emergency system. In other embodiments, the user can shut off the geo-location features to maintain privacy or to conserve battery life of the mobile device. Again, the user would have to enable these features (e.g., disabled GPS, Cell Tower Triangulation or IP address geo-location resolution) in order to report the user's location in an emergency. In embodiment disclosed herein the user can retain privacy and hardware configurations, but the user is able to use applications that need to know of actual geo-location to operate correctly (e.g., sending E911 SMS messages) in emergency situations without having to change preferences or hardware configuration under sometime stressful situations.

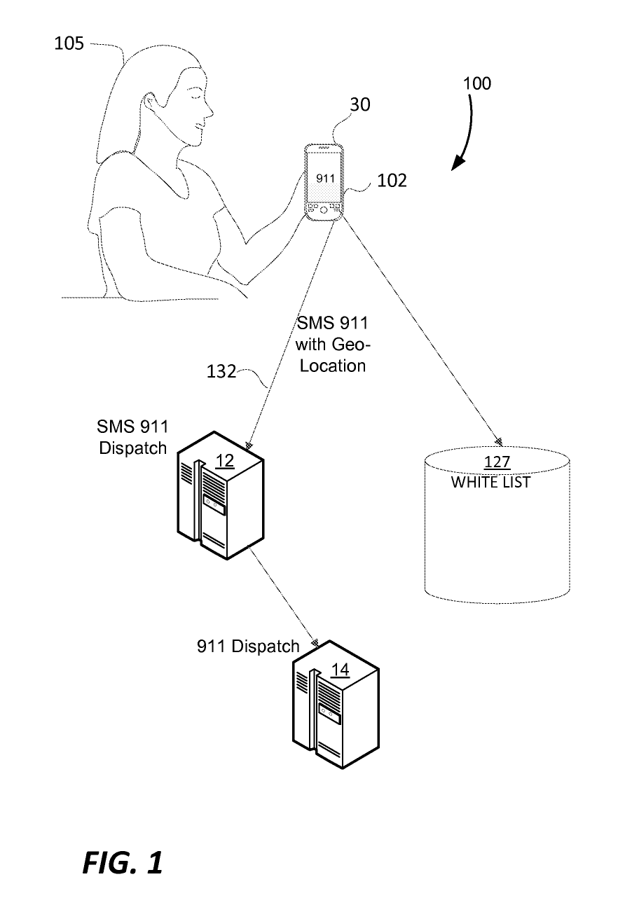

Now referring to FIG. 1, an exemplary mobile phone 30 operates in network environment 100 which includes an SMS911 dispatch facility 12, a E911 Dispatch facility 14 and white list storage database server 127. The mobile phone includes an application 102 that requires geo-location data of device. A user 105 and can send an SMS911 message 132 to an SMS911 dispatch facility 12. It is understood that the that the SMS911 dispatch facility 12, the E911 Dispatch facility 14 and the white list storage database server 127 can be separate systems or combined with each other. The SMS911 dispatch facility 12 generally includes a direct connection or alternatively other systems for dispatching 911 calls to the E911 dispatch facility 14.

In operation, the user 105 initiates the application 102 that requires geo-location data of device, here the application facilitates the transmission of an SMS911 text message with geo-location information 132. The application 102 can be a standalone application or can be integrated with the mobile phone 30 operating system. In another embodiment, the user 105 can directly text a message to “911,” and the mobile device can detect the destination and include geo-location data.

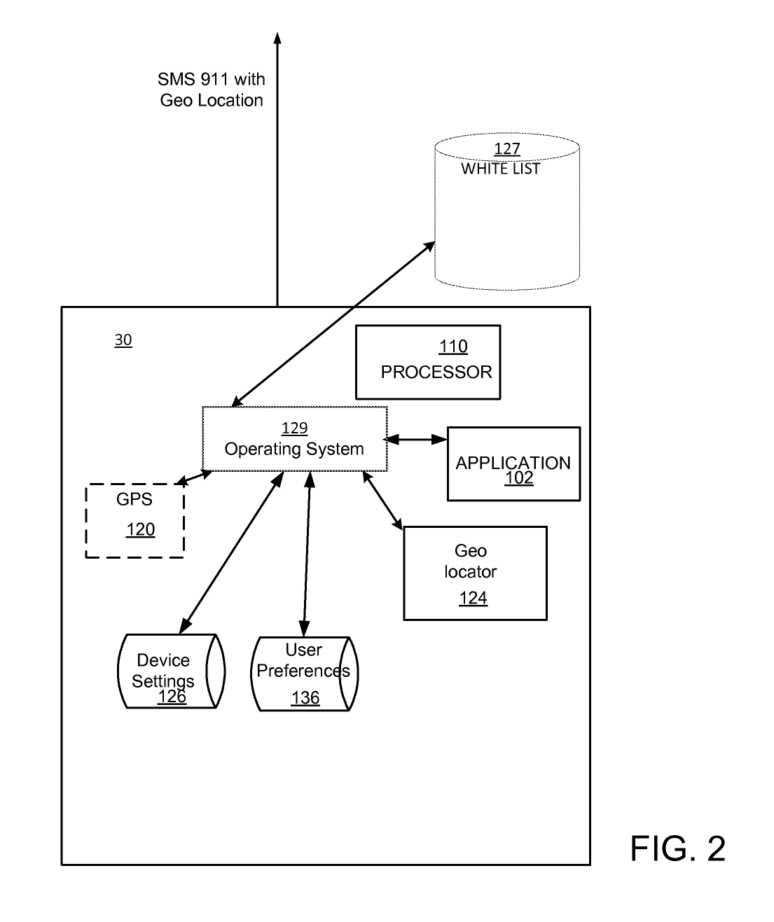

Now referring to FIG. 2, the exemplary mobile device 30 includes a processor 110, an operating system 129, an optional GPS 120, device settings storage 126, user preference storage 136, device settings storage 126, a geo-location subsystem 124. One or more applications 102 can be run on the mobile device 30. When the application 102 requests geo-location information from the operation system (OS) 129 of the mobile phone 30, for example, using an application programming interface (API), the OS 129 can respond with geo-location data or deny the request for geo-location data. If the application 102 is denied access to geo-location data (e.g., due to user settings preferences), the application 102 makes a request to override user preferences based on unusual circumstance scenario (e.g., an emergency call placed to SMS911). It is understood that an application 102 requesting access to geo-location data, can be run as a downloadable “app” or can be built into the mobile device and a standard function in the OS 129. The OS 129 has access to a whitelist 127 or other authorization systems which are used to determine if the application 102 is permitted access to geo-location data or whether a text message can include the geo-location data.

The mobile device can include, but is not limited to, a mobile phone, a smartphone (i.e. iPhone, Windows phone, Blackberry, Android phone, etc.), a tablet, a netbook, a personal digital assistant (PDA), wearable electronics, implantable electronics, or another mobile device capable of implementing the functionalities described herein. The mobile device 30 can include a storage devices which may include any type or form of non-volatile memory for storing the OS 129 which may include any type or form of Windows OS, Mac OS, Unix OS, Linux OS, Android OS, iPhone OS, mobile version of Windows OS, an embedded OS, or any other OS that may operate on mobile device 30. Mobile device 30 may also include software, and/or data space for storing additional data or information.

Generally a user maintains a level of privacy or operational energy efficiency by disabling/preventing the functioning of the GPS (if available) chipset function or other geo-location features of the mobile device by adjusting device settings 126 or user preference settings 136 in the mobile device 30 or by deactivating functionality in the mobile device. If the user attempts to use a function or application on a conventional device that requires geo-location data (e.g., a text message to SMS911 including location data) the text message will fail due to the user's privacy settings or operational efficiency settings. The function or application will not be able to access the geo-location data available from the device.

The a geo-location subsystem 124 can include cellular tower triangulation, directional, other RF signal strength measurement and derivative calculation methods, WiFi geo-location determination and IP address geo-location determination methods available for the mobile device. The whitelist 127 can be administered by some neutral third party (e.g., the device manufacturer, the OS supplier, the carrier if equipped with Commercial Mobile Radio Service CMRS capabilities, federal, state or municipal governments. The whitelist 127 includes which applications or functions are able to override the user's privacy or operational settings for geo-location purposes. The mobile device 30 and OS 129 have authorization mechanisms, based on the whitelist 127 to grant authorized applications to bypass user's privacy preferences, device setting or to activate device features in one of the following (not limiting) multiple scenarios:

100% of situations for a particular authorized application;

Emergency only (e.g.—detect SMS message being sent to destination: 911);

User defined (with exception of emergencies such as 911);

Mobile device and/or OS manufacturer defined situations; and

Government defined situations.

Any whitelist approved application would be required to comply with the authorization mechanism to override the user's preferences for geo-location function. An application that is “whitelisted” can override the user's privacy settings on the mobile device to access the geo-location data, whereas normally, because for example, a user has specified in their privacy settings that geo-location data is not available to applications.

In one embodiment, cryptographic techniques prevent unauthorized applications from spoofing an approved application on the whitelist. In these embodiments, the application 102, the whitelist database server 127 and the application, can use separately or a combination public key/based based, certificate based or other cryptographic techniques known in the art to restrict access to only applications authorized to be whitelisted. In one embodiment, the authorization process uses a cryptographic protocol similar to PGP (use of public, private and session keys). Using PGP as a sample model, the entities, the authoritative source (i.e., the whitelist database server 127), the OS 129 and the approved application 102 have a corresponding exchange of public and private keys and tokens which must match on both ends (whitelist database server 127 and mobile device 30), in order to validate the application is truly ‘authorized’ as a whitelisted application. In one embodiment, the override condition for a given application 102 would be available to the user and could be optionally displayed of to partially alleviate privacy concerns.

In one embodiment, the application 102 (e.g., an app that generates a SMS911 message and send it with a single click) makes request to OS 129 of the mobile device 30 is initially denied access to geo-location data. The application 102 then requests an override and can optionally include a reason (passed as parameters in an API call) to support the request. In response to the override request, the OS 129 queries the whitelist database server or other authorization sources, including but not limited to, an authoritative directory database provided and operated by the mobile service provider, device manufacturer, government or a third party service provider subscribed to by the user to provide authorization, to determine if granting of override is permissible. If the authorization mechanism determines request is valid (e.g., using cryptographic techniques the application 102 is authorized), the OS 129 grants the override and provides the requested geo-location data. If authorization mechanism determines request is invalid, the request for access to the geo-location information is denied and the failed request may optionally be reported by displaying, in one embodiment, the failed attempt to override blocked access to geo-location data to the user.

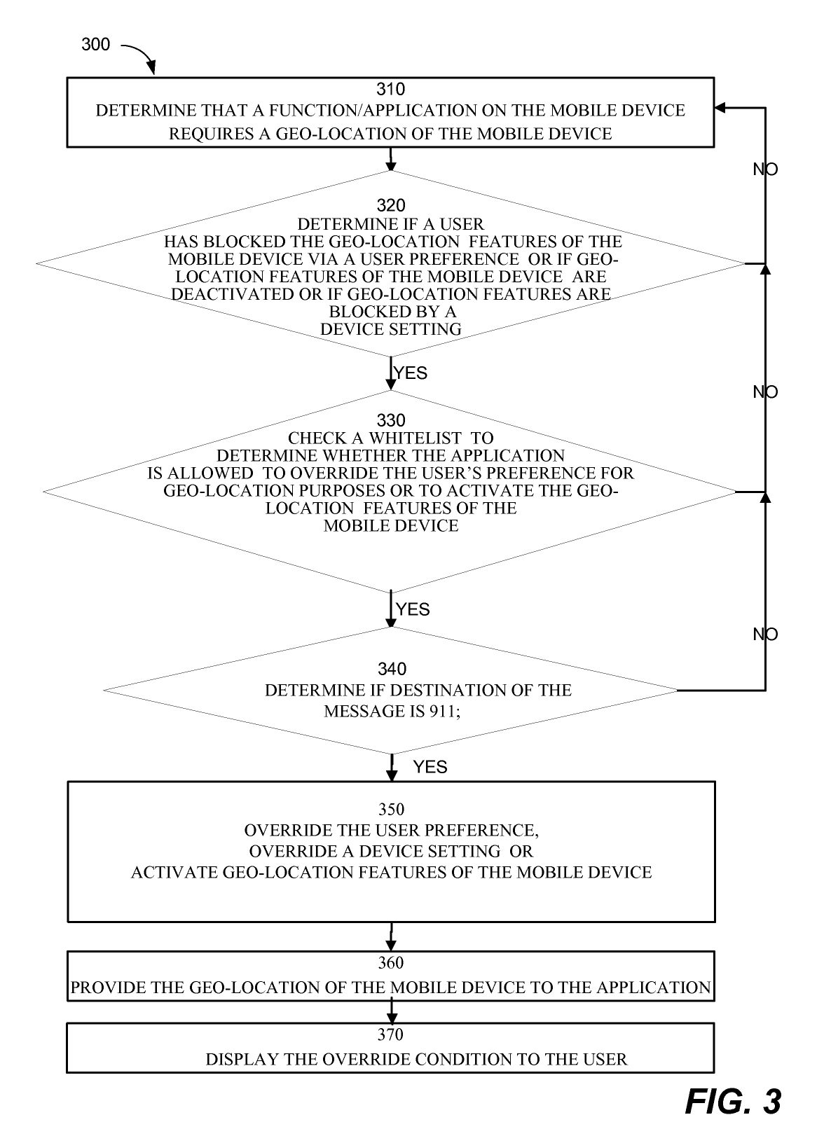

In FIG. 3, flowchart 300 diagrams an exemplary overall process of providing enhanced 911 services on a mobile device. In step 310, it is determined that a function/application on the mobile device requires a geo-location of the mobile device. In step 320 it is determined if a user has blocked the geo-location features of the mobile device via a user preference or if geo-location features of the mobile device are deactivated or if geo-location features are blocked by a device setting. If the geo-location features are blocked or deactivated, a whitelist is checked to determine whether the application is allowed to override the user's preference for geo-location purposes or to activate the geo-location features of the mobile device in step 330. If the whitelist does not include the requesting application or function, use of the geo-location features is blocked.

If the application is allowed to override, if is determined if the destination of the SMS message is 911 in step 340. This check occurs, for the example, where an application or function in the mobile device is attempting to send a message addressed with a short code to “911.” If the SMS message is addressed to “911,” the operating system allows an override of, for example, the user preference or a device setting or activates geo-location features of the mobile device at step 350. At step 360, the geo-location of the mobile device is provided to the application. The override condition can be displayed to the user in step 370.

While configurations of the system and method have been particularly shown and described with references to configurations thereof, it will be understood by those skilled in the art that various changes in form and details may be made therein without departing from the scope of the invention. As an example, the order of processing steps in the flow charts is not limited to the order shown herein. Accordingly, the present invention is not limited by the example configurations provided above.

What is claimed is:

1. A method to provide services on a mobile device comprising:
determining that an application on the mobile device requires a geo-location of the mobile device;
determining that the geo-location features of the mobile device are blocked;
checking a whitelist to determine whether the application is allowed to override the block;
overriding the block and providing the geo-location of the mobile device to the application.

2. The method of claim 1, further comprising displaying the override condition to the user.

3. The method of claim 1, further comprising determining that destination of the message is 911.

4. The method of claim 1, wherein determining that the geo-location features of the mobile device are blocked comprises determining that the user has blocked use of geo-location features via a user preference.

5. The method of claim 4, wherein overriding the block comprises overriding the user preference.

6. The method of claim 1, wherein determining that the geo-location features of the mobile device are blocked comprises determining that determining that the geo-location features of the mobile device are deactivated.

7. The method of claim 6, wherein overriding the block comprises activating the geo-location features of the mobile device.

8. The method of claim 1, wherein determining that the geo-location features of the mobile device are blocked comprises determining that the use of geo-location features via a user are blocked by device settings.

9. The method of claim 8, wherein overriding the block comprises overriding the device settings.

10. The method of claim 1, further comprising displaying a failed attempt to override blocked access to geo-location data to the user.

11. The method of claim 1, further comprising determining cryptographically that the application is authorized to access the geo-location features.

12. A method to provide enhanced 911 services on mobile devices comprising:
determining that an application on the mobile device requires a geo-location of the mobile device;
determining that one of:
the user has blocked use of geo-location features via a user preference;
the geo-location features of the mobile device are deactivated;
the geo-location features are blocked via a device setting;
checking a whitelist to determine whether the application is allowed to override the device's settings for geo-location purposes;
determining that destination of the message is 911;
unblocking access to geo-location features by one of:
overriding the user preference;
overriding the device's settings;
activating the and geo-location features of the mobile device;
providing the geo-location of the mobile device to the application; and
displaying the override condition to the user.
